(19) United States
(12) Patent Application Publication
(10) Pub. No.: US 2009/0242077 A1
(43) Pub. Date: Oct. 1, 2009

(54) BIOMASS HARVESTER

(76) Inventor: James B. Prohaska, Prior Lake, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/411,252

(22) Filed: Mar. 25, 2009

Related U.S. Application Data
(60) Provisional application No. 61/070,658, filed on Mar. 25, 2008.

(51) Int. Cl. A01G 23/091

(52) U.S. Cl. 144/4.1; 241/101.742

(57) ABSTRACT

A biomass harvester is configured to simultaneously clear-cut and gather both free-standing and random-lie biomass. Saw blades and gather aprons are located on arms that extend forwardly from an undercarriage. Cut and gathered biomass is reduced in size by a cutter head on-board and stored by a hopper on-board, thereby reducing the costs associated with using multiple machines to harvest biomass.

### CROSS-REFERENCE TO RELATED APPLICATION(S)

This application claims the benefit of U.S. Provisional Application 61/070,658 filed Mar. 25, 2008.

### BACKGROUND

The present invention relates generally to harvesters and more particularly, to a self-propelled biomass harvester for harvesting trees and/or plants.

### SUMMARY

An exemplary embodiment of the present invention is a machine for harvesting biomass including an undercarriage, an engine mounted on the undercarriage, and a cab mounted on the undercarriage in front of the engine. Left and right tracks or wheels are attached to a left and right side of the undercarriage, respectively. A hopper is mounted on the undercarriage behind the engine, and an auger extends forwardly from the hopper along the undercarriage. A cutter head is located at a forward end of the auger, feeder rolls are located on a forward side of the cutter head, and a center apron is located on a forward side of the feeder rolls. Left and right gathering aprons extend forwardly from the left and right sides of the undercarriage, respectively, such that the gathering aprons are located on either side of the center apron. Left and right saw blades are mounted beneath the left and right gathering aprons, respectively, such that the machine is configured to simultaneously clear-cut and gather both free-standing and random-lie biomass.

Another exemplary embodiment of the present invention is a machine for harvesting biomass including a cab and an undercarriage connected to a bottom of the cab. A left track or set of wheels is attached to a left side of the undercarriage and a right track or set of wheels is attached to a right side of the undercarriage. An engine is connected to a top of the undercarriage behind the cab and between the left and right tracks. A left arm extends forward from the left side of the undercarriage and a right arm extends forward from the right side of the undercarriage. Each arm includes near and far saw blades and a gathering apron. The near saw blade is adjacent the undercarriage and the far saw blade is connected to the near saw blade. The gathering apron extends horizontally across a top of the near and far saw blades. A center apron is mounted vertically to the left and right arms at a location above the near blades and between the gathering aprons. Upper and lower feed rolls are connected to the undercarriage at a location behind the center apron. A cutter head is connected to the undercarriage at a location behind the upper and lower feed rolls. An auger extends horizontally from the cutter head to a rear end of the undercarriage, and to a hopper attached to the rear of the undercarriage.

### BRIEF DESCRIPTION OF THE DRAWINGS

FIG. 1 is a schematic cross sectional view of a biomass harvester in accordance with the present invention, with portions shown in phantom.

FIG. 2 is a schematic top view of the biomass harvester from FIG. 1, with portions shown in phantom.

### DETAILED DESCRIPTION

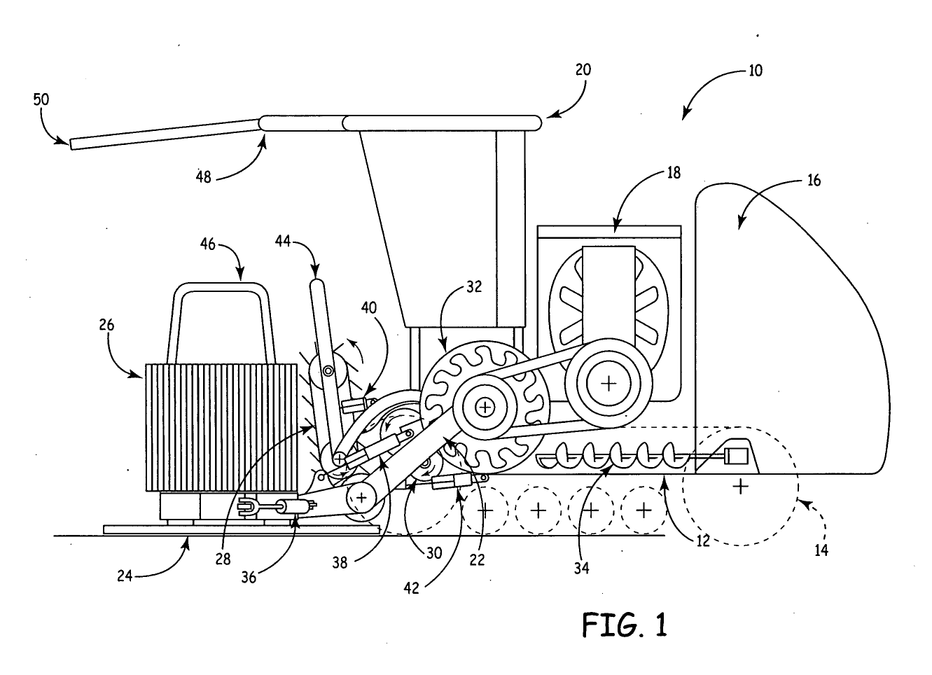

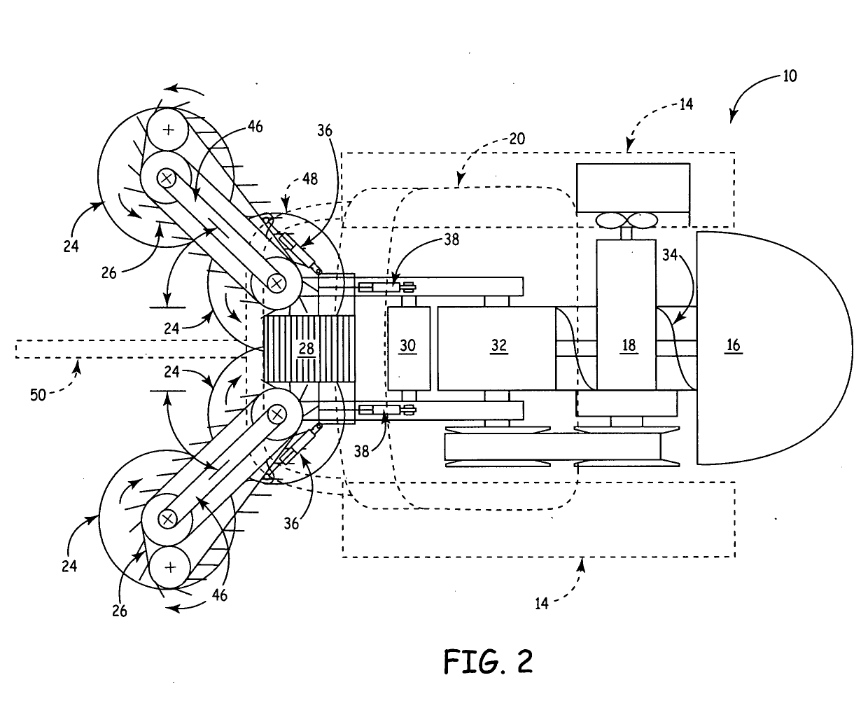

FIG. 1 is a schematic cross sectional view and FIG. 2 is a schematic top view of biomass harvester 10 in accordance with the present invention. Depicted in FIGS. 1 and 2 are the components of biomass harvester 10: undercarriage 12, track 14, hopper 16, engine 18, cab 20, arms 22, saw blades 24, gathering aprons 26, center apron 28, feed rolls 30, cutter head 32, auger 34, cylinders 36, 38, 40, 42, bumper bars 44, 46, 48, and probe 50. Biomass harvester 10 is a self-propelled machine used to harvest biomass directly from the location where it is grown or exists.

Biomass harvester 10 is supported above a surface or ground by undercarriage 12. Undercarriage 12 extends horizontally so that it is substantially parallel to the surface or ground. Extending outwardly from either side of undercarriage 12 to contact the ground are tracks 14. Left track 14 extends laterally from a left side of undercarriage 12 and Right track 14 extends laterally from a right side of undercarriage 12. Projecting upwardly from a top surface of undercarriage 12 is vertical-oriented hopper 16. Located in front of hopper 16 and extending upwardly from the top surface of undercarriage is engine 18, which can also include a cooling system. Cab 20 is connected to and extending upwardly from undercarriage 12, but at a location forward of engine 18. In the depicted embodiment, cab 20 is the tallest portion of biomass harvester 10. Located beneath cab 20 and attached to a top surface of undercarriage 12 are arms 22. Left arm 22 extends forwardly from the left side of undercarriage 12 and right arm 22 extends forwardly from the right side of undercarriage 12. Each arm 22 includes two saw blades 24, first or near saw blade 24 being located near undercarriage 12 and second or far saw blade 24 being attached to a far side of first saw blade 24 so it is located in a spaced relationship or far from undercarriage 12. Each arm 22 also includes at least one gathering apron 26. Gathering aprons 26 are located above and extend vertically upwards from saw blades 24. Located centrally between arms 22 at the location where arms 22 extend forwardly from undercarriage 12 is center apron 28. Center apron 28 is attached to, and oriented substantially vertically with respect to, arms 22. Behind center apron 28 on a top surface of undercarriage 12 are feed rollers 30. In the depicted embodiment there are two upper feed rollers 30 and two lower feed rollers 30, such that there is left set of upper and lower feed rollers 30 and right set of upper and lower feed rollers 30. Located behind feed rollers 30 and connected to a top surface of undercarriage 12 is circular cutter head 32 including cutting or chopping blades. Cutter head 32 is mounted in an approximate center of undercarriage 12 in front of engine 28 and beneath cab 20. Behind cutter head 32 and extending backwards to hopper 16 is auger 34. Auger 34 is attached to and runs along undercarriage 12 beneath engine 18. When biomass harvester 10 is in use, biomass is cut by blades 24, gathered by aprons 26, 28, fed by rolls 30, cut by head 32, conveyed by auger 34, and stored by hopper 16.

Undercarriage 12 provides structure to biomass harvester 10 by supporting the load of hopper 16, engine 18, cab 20, and arms 22. Undercarriage 12 can also include a mechanism to prevent rolling of biomass harvester 10 as it traverses steep inclines of 100% or more. Tracks 14 provide movement to biomass harvester 10 and steering is accomplished by individually controlling left and right track 14 speeds and directions. Tracks 14 are preferred over wheels because tracks 14 reduce soil compaction and disturbance. In other embodiments, however, left and right sets of wheels may be used in place of tracks 14. Hopper 16 serves as on-board storage for freshly cut biomass. Once harvesting is complete or hopper 16 is full, a conveyor empties biomass from hopper 16 into a truck or other container for transport to another location, such as but not limited to, an energy plant. Hopper 16 can include vents to allow air flow from cutter head 32 through auger 34 to hopper 16. Inclusion of air vents in hopper 16 controls dust and particulate matter from escaping haphazardly from biomass harvester 10. Engine 18 can be any standard engine capable of powering biomass harvester 10, preferably energy sufficient to operate biomass harvester 10 on slopes of 100% or more. In the depicted embodiment, engine 18 includes a cooling system. Cab 20 is an enclosure configured to house an operator controlling biomass harvester 10. Arms 22 carry saw blades 24 and gathering aprons 26 out in front of undercarriage 12. Saw blades 24 are oriented horizontally and rotate to cut standing or resting trees and plants. Saw blades 24 are designed to cut standing trees and plants at or very near the ground resulting in maximum harvesting of biomass and smoother traversal of biomass harvester 10 over cut stumps. In the depicted embodiment, left saw blades 24 rotate clockwise and right saw blades 24 rotate counter-clockwise causing cut biomass to be thrown toward center apron 28 for processing. Gathering aprons 26 gather and direct cut biomass toward center apron 28. Like saw blades 24, left gathering apron 26 rotates clockwise and right gathering apron 26 rotates counter-clockwise. Center apron 28 rotates with a forward side traveling downwards to send cut biomass into feed rolls 30. Upper and lower feed rolls 30 turn in opposing directions to encourage gripping, compression, and stabilization of biomass. In the depicted embodiment, a set of upper and lower feed rolls 30 are positioned on both the left side and the right side of undercarriage to enable two point contact and stabilization of biomass. Upper feed rolls 30 can move vertically to compensate for varying sizes of biomass and bottom feed rolls 30 are spaced apart horizontally to allow for rocks to drop out between bottom feed rolls 30. The rotational speed of feed rolls 30 can be linked to engine 18 rotations per minute and controlled by an on-board computer to keep biomass feed rate within an optional power range of engine 18. An operator can stop and reverse the rotational direction of feed rolls 30 to clear a clog. Cutter head 32 cuts biomass down into smaller pieces. Piece or particle size is determined by feed rate of biomass into cutter head 32, which is controlled by feed roll 30 speed. Cut biomass is transported by auger 34 to hopper 16. Auger 34 can be shortened to make space for a pelletizer or briquette-making unit to further condense biomass before storage in hopper 16.

Several cylinders 36, 38, 40, 42 are included on biomass harvester 10, which allow an operator to alter the position of saw blades 24, gathering aprons 26, and center apron 28. Cut width cylinders 36 are attached to an outside surface of arms 22 near the location where arms 22 project forwardly beyond undercarriage 12. Cut tilt cylinders 38 extend across a top surface of arms 22 behind cut width cylinders 36 adjacent feed rollers 30. Center apron tilt cylinder 40 is attached to center apron 28 at a location above both cut width cylinders 36 and feed rollers 30. Lift arm cylinders 42 are attached to, and extend between, arms 22 and undercarriage 12. Each cylinder 36, 38, 40, 42 is named for the function it performs. An operator can use cut width cylinders 36 to control the horizontal swing position of second or far saw blades 24. It may be desirable to narrow cut width for at least the following reasons: compressing biomass located between arms 22, traveling between to objects which are not to be cut, and moving biomass harvester 10 without operating saw blades 24. Cut tilt cylinders 38 are used to alter the angle of second or far saw blades 24 with respect to the ground. An operator may choose to change the angle of attack for saw blades 24 in order to more closely trim terrain. Center apron tilt cylinder 40 tips center apron 28 forwardly and back to approximately vertical to aid in biomass compression and movement. Lastly, arm lift cylinders 42 raise and lower arms 22 with respect to the ground in order to position saw blades 24 at a desired height for cutting or transport.

Bumper bars 44, 46, 48 and probe 50 are included on biomass harvester 10. First bumper bar 44 extends vertically upwards from a top surface of center apron 28. Second bumper bars 46 extend vertically upward from top surface of gathering aprons 26. Third bumper bar 48 extends horizontally forward from a top front surface of cab 20. Bumper bars 44, 46, 48 can be shaped like U-shaped having opposing vertical sections and horizontally extending portion connecting the two vertical sections. Probe 50 extends horizontally forward from third bumper bar 48 so probe 50 is projecting from a top of cab 20 over second bumper bars 46, gathering aprons 26, and saw blades 24. A forward tip of probe 50 is the most forward part of biomass harvester 10. Bumper bars 44, 46, 48 are positioned to push freshly cut but still standing biomass forward and between arms 22 for processing by biomass harvester 10. Bumper bars 44, 46, 48 also help protect cab from being damaged by falling trees and/or plants. Probe 50 is positioned to aid an operator in viewing what lies ahead of biomass harvester 10 when biomass is thick. Probe 50 can include a light and/or a camera connected to a monitor in the cab 20. Biomass harvester 10 can additionally be equipped with GPS and yield monitoring tools to measure biomass yield/moisture, position, speed and weather conditions.

Biomass harvester 10 is intended to harvest trees, plants and/or other biomass directly from the location where it grows and/or exists. Cutting blades 24 cut biomass from its free-standing and/or random lie positions and gathering aprons 26 convey material centrally toward center apron 28. Center apron 28 directs biomass into feed rolls 30 which consolidate, compress, and convey biomass at a predetermined rate to cutting head 32. Cutting head 32 chops or cuts biomass into smaller pieces and dumps the cut biomass onto auger 34, which conveys biomass to hopper 16 for storage. If desired, a pelletizer or briquette-making unit can be added before storage of biomass in hopper 16. Biomass harvester 10 is a machine capable of simultaneously clear-cutting and gathering free-standing and random-lie biomass. The clear-cut method allows biomass harvester 10 to cut a path anywhere the terrain will allow and can optimize management of combustible biomass for forest fire control and for energy production. Biomass harvester 10 is intended to be used for single-pass harvesting thereby reducing soil disturbance. On board reduction of biomass volume and temporary storage of biomass reduces the amount of machinery needed for harvesting. Use of a single machine and single operator reduces the costs associated with collection of biomass.

Although the present invention has been described with reference to preferred embodiments, workers skilled in the art will recognize that changes may be made in form and detail without departing from the spirit and scope of the invention.

1. A machine for harvesting biomass, the machine comprising:
an undercarriage;
an engine mounted on the undercarriage;
a cab mounted on the undercarriage in front of the engine;
left and right tracks or wheels attached to a left and right side of the undercarriage, respectively;
a hopper mounted on the undercarriage behind the engine;
an auger extending forwardly from the hopper along the undercarriage;
a cutter head located at a forward end of the auger;
feeder rolls located on a forward side of the cutter head;
a center apron located on a forward side of the feeder rolls;
left and right gathering aprons extending forwardly from the left and right sides of the undercarriage, respectively, such that the gathering aprons are located on either side of the center apron; and
left and right saw blades mounted beneath the left and right gathering aprons, respectively.

2. The machine of claim 1, further comprising:
left and right cut width cylinders connected to the left and right saw blades, respectively.

3. The machine of claim 1, further comprising:
left and right cut tilt cylinders connected to the left and right saw blades, respectively.

4. The machine of claim 1, further comprising:
left and right lift cylinders connected to the left and right saw blades, respectively.

5. The machine of claim 1, further comprising:
a center apron tip cylinder connected to the center apron.

6. The machine of claim 1, further comprising:
a bumper bar extending forwardly from a top of the cab.

7. The machine of claim 1, further comprising:
left and right bumper bars extending upwardly from a top of the left and right gathering aprons, respectively.

8. The machine of claim 1, further comprising:
a bumper bar extending upwardly from a top of the center apron.

9. The machine of claim 1, further comprising
a probe extending forwardly from a top of the cab.

10. A machine for harvesting biomass, the machine comprising:
a cab;
an undercarriage connected to a bottom of the cab;
left and right tracks or wheels, attached to a left side and a right side of the undercarriage, respectively;
an engine connected to a top of the undercarriage behind the cab;
left and right arms, the left arm extending forward from the left side of the undercarriage and the right arm extending forward from the right side of the undercarriage, each arm comprising:
near and far saw blades, the near saw blade adjacent the undercarriage and a far saw blade connected to the near saw blade; and
a gathering apron extending horizontally across a top of the near and far saw blades;
a center apron mounted vertically to the left and right arms at a location above the near blades and between the gathering aprons;
upper and lower feed rolls connected to the undercarriage at a location behind the center apron;
a cutter head connected to the undercarriage at a location behind the upper and lower feed rolls;
an auger extending horizontally from the cutter head to a rear end of the undercarriage; and
a hopper attached to the rear of the undercarriage.

11. The machine of claim 10, further comprising:
left and right cut width cylinders connected to the left and right arms, respectively.

12. The machine of claim 10, further comprising:
left and right cut tilt cylinders connected to the left and right arms, respectively.

13. The machine of claim 10, further comprising:
left and right lift cylinders connected to the left and right arms, respectively.

14. The machine of claim 10, further comprising:
a center apron tip cylinder connected to the center apron.

15. The machine of claim 10, further comprising:
a bumper bar extending forwardly from a top of the cab.

16. The machine of claim 1, further comprising:
left and right bumper bars extending upwardly from a top of the left and right arms, respectively.

17. The machine of claim 1, further comprising:
a bumper bar extending upwardly from a top of the center apron.

18. The machine of claim 1, further comprising
a probe extending forwardly from a top of the cab.
